(19) United States
(12) Patent Application Publication
(10) Pub. No.: US 2013/0262255 A1
(43) Pub. Date: Oct. 3, 2013

(54) FACILITATING TRANSACTIONS WITH GRANULAR JOB OUTCOMES

(71) Applicant: Strategyn Equity Partners, Inc., San Francisco, CA (US)

(72) Inventors: James M. HAYNES, III, San Francisco, CA (US); Anthony W. ULWICK, Mill Valley, CA (US)

(21) Appl. No.: 13/629,527

(22) Filed: Sep. 27, 2012

Related U.S. Application Data
(60) Provisional application No. 61/539,709, filed on Sep. 27, 2011.

(51) Int. Cl. G06Q 30/06

(52) U.S. Cl. CPC G06Q 30/0605
USPC 705/26.2

(57) ABSTRACT

Disclosed is facilitating granular job used vehicle transactions. Methods can include assessing a market value of a vehicle, integrating the assessed market value of the identified vehicle into a market model including an adaptive pricing strategy, and setting a seller-side price for the identified vehicle based on the adaptive pricing strategy. Methods can also include building a marketing model of the identified vehicle based on the adaptive pricing strategy, attracting a set of potential buyers based on the marketing model, receiving buyer-related information about each of the set of potential buyers, and identifying one or more qualified buyers from the set of potential buyers based on the buyer-related information of the one or more qualified buyers. Methods can also include facilitating a sale of the vehicle from the seller to at least one of the one or more qualified buyers.

### CROSS-REFERENCE TO RELATED APPLICATIONS

This application claims priority to U.S. provisional Ser. No. 61/539,709, filed Sep. 27, 2011, entitled “IMPLEMENTATION OF SYSTEM AND METHOD FOR SELLING A USED CAR,” which is incorporated by reference.

### BACKGROUND

Presently, used vehicle sales are unnecessarily complicated transactions. The sales often involve functionally complex decisions to be made with insufficient transactional information. For example, a seller of a used vehicle typically needs to find a market for the vehicle, establish a price point or price range, and weed through a sea of prospective buyers. To further complicate a seller's dilemma, prospective buyers may be insolvent or otherwise be unable to assume ownership or possession of a used vehicle for sale even though the prospective buyers may be able to communicate an offer for the sale. In many instances, sellers resolve these dilemmas by accepting the first bid that meets their price range. However, such a resolution only causes sellers to price used vehicles below their true market value.

On the other side of a used vehicle transaction, prospective buyers usually need to sort through a variety of used vehicles available for sale. A prospective buyer may confront loose assumptions of market value and quality of a car for sale. In many instances, a prospective buyer may need to deal with the fact that a seller's representation of a used vehicle's cost does not establish the car's value. A prospective buyer may also face the fact that a seller may be unable or too unsophisticated to transfer ownership or possession of a used vehicle despite being able to accept an offer to purchase the used vehicle. Underlying these complex dilemmas is the fact that neither a seller nor a buyer of a used vehicle have sufficient information to enter into and execute a used vehicle transaction in an economically efficient manner.

### SUMMARY

Disclosed are methods and systems of facilitating used car transactions with granular job outcomes. The method may include identifying a vehicle for sale by a seller, and may include assessing a market value of the identified vehicle based on one or more of a condition, a make, and a model of the identified vehicle. The method may include integrating the assessed market value of the identified vehicle into a market model based on market information related to the make and the model of the identified vehicle, the market model including an adaptive pricing strategy. The method may include setting a seller-side price for the identified vehicle based on the adaptive pricing strategy. The method may include building a marketing model of the identified vehicle based on the adaptive pricing strategy. The method may also include attracting a set of potential buyers based on the marketing model and receiving buyer-related information about each of the set of potential buyers. The method may further include identifying one or more qualified buyers from the set of potential buyers based on the buyer-related information of the one or more qualified buyers and facilitating a sale of the vehicle from the seller to at least one of the one or more qualified buyers.

Facilitating the sale of the identified vehicle may include receiving a bid for the identified vehicle from the one qualified buyer, and facilitating acceptance of the bid by the seller. Facilitating the sale of the identified vehicle can include facilitating legal transfer of the identified vehicle from the seller to the one qualified buyer and facilitating payment for the identified vehicle from the one qualified buyer to the seller. Facilitating the sale of the identified vehicle can include providing a set of instructions to the seller to physically prepare the vehicle for delivery to the one qualified buyer and coordinating the delivery of the vehicle from the seller to the one qualified buyer.

A method may include receiving financial information and vehicle preference information from a potential buyer, and assigning a vehicle budget to the potential buyer based on one or more of the financial information and the vehicle preference information. The method may include assigning a vehicle purchase category to the potential buyer based on one or more of the financial information and the vehicle preference information. The method may include providing to the potential buyer a set of vehicles for sale based on the vehicle budget and the vehicle purchase category and receiving a selection of one of the set of vehicles. The method may include updating a market model for the selected vehicle, the market model based on market information related to a make and a model of the selected vehicle, the market model including an adaptive pricing strategy, and setting a buyer-side price for the selected vehicle, the buyer-side price based on the adaptive pricing strategy and a marketing model for the selected vehicle. The method may include facilitating a sale of the selected vehicle from the seller to the potential buyer.

The method may include calculating maintenance costs for the selected vehicle and validating one or more of: a safety rating, an aesthetic quality, and a vehicle handling rating of the selected vehicle.

A method may include assessing a market value of each a plurality of vehicles for sale, the assessing based on one or more of a condition, a make, and a model of each vehicle, and integrating the assessed market value of one of the plurality of vehicles into a market model based on market information related to the make and the model of the one vehicle, the market model including an adaptive pricing strategy for the one vehicle. The method may include setting a seller-side pricing preference for the one vehicle based on the adaptive pricing strategy for the one vehicle. The method may include obtaining a set of buyers having one or more of a vehicle budget and a vehicle purchase category in accordance with the adaptive pricing strategy for the one vehicle. The method may include assigning each buyer in the set of buyers a purchase ranking corresponding to an extent one or more of the vehicle budget and the vehicle purchase category corresponds to the adaptive pricing strategy for the one vehicle. The method may include matching one of the buyers in the set of buyers with the one vehicle according to the purchase ranking of the one buyer. The method may include obtaining, for the one buyer, a buyer-side pricing preference for the one vehicle based on the adaptive pricing strategy and a marketing model for the one vehicle. The method may include facilitating a sale of the one vehicle to the one buyer.

### BRIEF DESCRIPTION OF THE DRAWINGS

FIG. 1 shows an example of a granular job vehicle transaction system.

FIG. 2 shows an example of a granular vehicle transaction system that matches a used vehicle buyer with a used vehicle seller.

FIG. 3 shows an example of a granular job vehicle selling engine.

FIG. 4 shows an example of a granular job vehicle buying engine.

FIG. 5 shows an example of a granular job vehicle party matching engine.

FIG. 6 shows an example of a method for executing a job map for selling a vehicle.

FIG. 7 shows an example of a method for executing a job map for buying a vehicle.

FIG. 8 shows an example of a method for executing job map for matching a vehicle buyer and vehicle seller.

FIG. 9 shows an example of a computer system.

### DETAILED DESCRIPTION

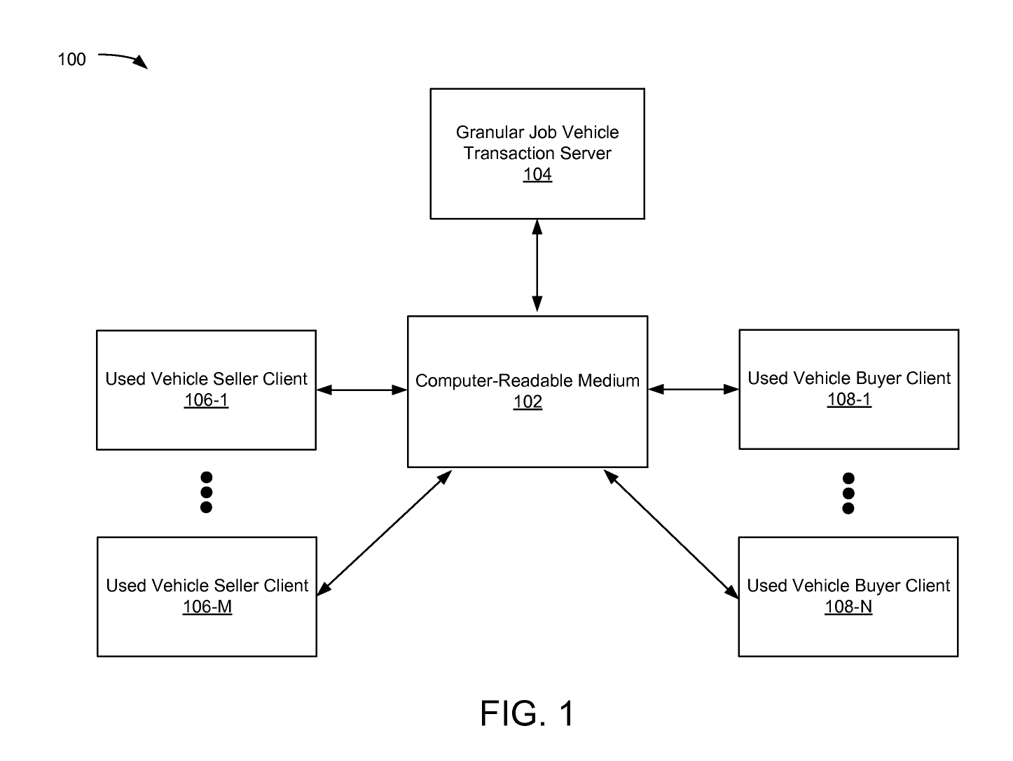

FIG. 1 shows an example of a granular job vehicle transaction system 100. In the example of FIG. 1, the granular job vehicle transaction system 100 includes a computer-readable medium 102, a granular job vehicle transaction server 104, used vehicle seller clients 106-1 to 106-M (collectively referred to as the used vehicle seller clients 106), and used vehicle buyer clients 108-1 to 108-N (collectively referred to as the used vehicle buyer clients 108).

As used in this paper, a job is a task that customers or participants in a consumption chain are trying to get done in a particular market. A job map is the combination of jobs that complete a comprehensive task. The jobs described in this paper are metric-oriented in that data provided in association with the job is in the form of or can be translated into a numeric value. The jobs described in this paper are need-oriented in that the job is divorced from or agnostic with respect to specific solutions or brands. Advantageously, job outcomes can thus be mapped to specific solutions (or products) available in the market prior to settling on or comparing to a specific solution. Ideally, the job map should incorporate all central tasks that must be accomplished to execute the job map. Although the sequence is not in all cases critical, depending upon the implementation and/or job map, the jobs can be organized in an optimal sequence most conducive to efficiently, effectively, or successfully completing the comprehensive task. In some cases, there may be some planning that occurs before a job map is executed, such as compiling data into a datastore or confirming job executors. In some cases, there may be some follow-up to ensure the comprehensive task is carried out, such as monitoring or verification, and potentially modification or adjustment. In some cases, it may be desirable to conclude a job map to prepare for a next job cycle, such as by storing feedback, removing inventory, or the like.

A job map can be customized in accordance with market needs. A market can be framed in a number of ways, including across substitutes, across product group competitors, across product form competitors, or within a context. In the primary specific implementation described in this paper, the job map is defined within a used car transaction context. Used car transaction maps are difficult to derive due to the relative uniqueness of the used cars, great variability in product parameters, regulations, maintenance requirements, and the like. For this reason, to date, used vehicle transactions have been imperfect.

In some examples described in this paper, it may be desirable to emphasize the granularity of the job map. Specifically, a job that is metric- and need-oriented can be incorporated into a job map as a discrete component of the job map. Granularity is possible because the jobs are interchangeable for a given market, regardless of the solutions (brands) that currently occupy the defined market. For given inputs to the granular jobs, there are outcomes that can and do impact the outcome of the job map, but the inputs to a first granular job do not impact inputs to a second granular job (except to the extent the output of the first granular job is input to the second granular job). In a vehicle transaction context, the granularity of the jobs becomes an aspect of ensuring that optimal solutions are identified for a job map outcome, and enables levers to be moved with respect to particular granular jobs to emphasize the importance of one particular granular job relative to others on a customizable (though not necessarily customized if not implemented) basis.

In the example of FIG. 1, the computer-readable medium 102 can include a networked system that includes several computer systems coupled together, such as the Internet, or a device for coupling components of a single computer, such as a bus. The term “Internet” as used herein refers to a network of networks that uses certain protocols, such as the TCP/IP protocol, and possibly other protocols such as the hypertext transfer protocol (HTTP) for hypertext markup language (HTML) documents that make up the World Wide Web (the web). Content is often provided by content servers, which are referred to as being “on” the Internet. A web server, which is one type of content server, is typically at least one computer system which operates as a server computer system and is configured to operate with the protocols of the web and is coupled to the Internet. The physical connections of the Internet and the protocols and communication procedures of the Internet and the web are well known to those of skill in the relevant art. For illustrative purposes, it is assumed the computer-readable medium 102 broadly includes, as understood from relevant context, anything from a minimalist coupling of the components illustrated in the example of FIG. 1, to every component of the Internet and networks coupled to the Internet.

A computer system, as used in this paper, is intended to be construed broadly. In general, a computer system will include a processor, memory, non-volatile storage, and an interface. A typical computer system will usually include at least a processor, memory, and a device (e.g., a bus) coupling the memory to the processor.

The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The term “computer-readable storage medium” is intended to include physical media, such as memory.

The bus can also couple the processor to the non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable storage medium.” A processor is considered to be “configured to execute a program” when at least one value associated with the program is stored in a register readable by the processor.

The bus can also couple the processor to the interface. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device.

In one example of operation, the computer system can be controlled by operating system software that includes a file management system, such as a disk operating system. File management systems are typically stored in non-volatile storage and cause the processor to execute the various acts required by the operating system to input and output data and to store data in the memory, including storing files on the non-volatile storage. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. Another example of operating system software with associated file management system software is VM (or VM/CMS), which refers to a family of IBM virtual machine operating systems used on IBM mainframes System/370, System/390, zSeries, System z, and compatible systems, including the Hercules emulator for personal computers.

Some portions of this paper may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not necessarily inherently related to any particular computer or other apparatus. Various general purpose systems may be used with programs to configure the general purpose systems in a specific manner in accordance with the teachings herein, or it may prove convenient to construct specialized apparatus to perform the methods of some embodiments. The required structure for a variety of these systems will appear from the description below. In addition, the techniques are not described with reference to any particular programming language, and various embodiments may thus be implemented using a variety of programming languages.

Referring once again to the example of FIG. 1, the granular job vehicle transaction server 104 is coupled to the computer-readable medium 102. The granular job vehicle transaction server 104 can be implemented on a known or convenient computer system. Only one instance of the granular job vehicle transaction server 104 is illustrated in FIG. 1, but it should be understood that specific implementations could have multiple servers. Moreover, partial functionality might be provided by a first device and partial functionality might be provided by a second device, where together the first and second devices provide the full functionality attributed to the granular job vehicle transaction server 104.

In the example of FIG. 1, the granular job vehicle transaction server 104 can include engines and/or datastores to assist buyers and sellers enter into intelligent transactions for used vehicles. Engines, as described below and in this paper generally, refer to computer-readable media coupled to a processor. The computer-readable media have data, including executable files, the processor can use to transform the data and create new data. An engine can include a dedicated or shared processor and, typically, firmware or software modules that are executed by the processor. Depending upon implementation-specific or other considerations, an engine can be centralized or its functionality distributed. An engine can include special purpose hardware, firmware, or software embodied in a computer-readable medium for execution by the processor. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

As described in this paper, a datastore can be implemented, for example, as software embodied in a physical computer-readable medium on a general- or specific-purpose machine, in firmware, in hardware, in a combination thereof, or in an applicable known or convenient device or system. Datastores described in this paper are intended, if applicable, to include any organization of data, including tables, comma-separated values (CSV) files, traditional databases (e.g., SQL), or other known or convenient organizational formats.

In an example of a system where the datastore is implemented as a database, a database management system (DBMS) can be used to manage the datastore. In such a case, the DBMS may be thought of as part of the datastore or as part of the granular job vehicle transaction server 104, or as a separate functional unit (not shown). A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Alpha Five, DataEase, Oracle database, IBM DB2, Adaptive Server Enterprise, FileMaker, Firebird, Ingres, Informix, Mark Logic, Microsoft Access, InterSystems Cache, Microsoft SQL Server, Microsoft Visual FoxPro, MonetDB, MySQL, PostgreSQL, Progress, SQLite, Teradata, CSQL, OpenLink Virtuoso, Daffodil DB, and OpenOffice.org Base, to name several.

Database servers can store databases, as well as the DBMS and related engines. Any of the datastores described in this paper could presumably be implemented as database servers. It should be noted that there are two logical views of data in a database, the logical (external) view and the physical (internal) view. In this paper, the logical view is generally assumed to be data found in a report, while the physical view is the data stored in a physical storage medium and available to a specifically programmed processor. With most DBMS implementations, there is one physical view and an almost unlimited number of logical views for the same data.

A DBMS typically includes a modeling language, data structure, database query language, and transaction mechanism. The modeling language is used to define the schema of each database in the DBMS, according to the database model, which may include a hierarchical model, network model, relational model, object model, or some other applicable known or convenient organization. An optimal structure may vary depending upon application requirements (e.g., speed, reliability, maintainability, scalability, and cost). One of the more common models in use today is the ad hoc model embedded in SQL. Data structures can include fields, records, files, objects, and any other applicable known or convenient structures for storing data. A database query language can enable users to query databases, and can include report writers and security mechanisms to prevent unauthorized access. A database transaction mechanism ideally ensures data integrity, even during concurrent user accesses, with fault tolerance. DBMSs can also include a metadata repository; metadata is data that describes other data. The granular job vehicle transaction server 104 can also include engines and/or datastores to assist used vehicle buyers and sellers with similar economic incentives find one another and intelligently enter into an efficient used vehicle transaction.

In the example of FIG. 1, the used vehicle seller clients 106 are coupled to the computer-readable medium 102. The used vehicle seller clients 106 can be implemented as clients of the granular job vehicle transaction server 104. Regardless of how the relationship with the granular job vehicle transaction server 104 is characterized, the used vehicle seller clients 106 can receive data from the granular job vehicle transaction server 104, which can include executable software, served by the granular job vehicle transaction server 104. In this example, the used vehicle seller clients 106 can include engines, datastores, and/or user interfaces to assist sellers enter into intelligent and economically efficient transactions for the sale of their cars.

Further, in the example of FIG. 1, the used vehicle buyer clients 108 are coupled to the computer-readable medium 102. The used vehicle buyer clients 108 can be implemented as clients of the granular job vehicle transaction server 104. Regardless of how the relationship with the granular job vehicle transaction server 104 is characterized, the used vehicle buyer clients 108 receive data from the granular job vehicle transaction server 104, which can include executable software, served by the granular job vehicle transaction server 104. In this example, the used vehicle buyer clients 108 can include engines, datastores, and/or user interfaces to assist used vehicle buyers enter into intelligent and economically efficient transactions for the purchase of used vehicles.

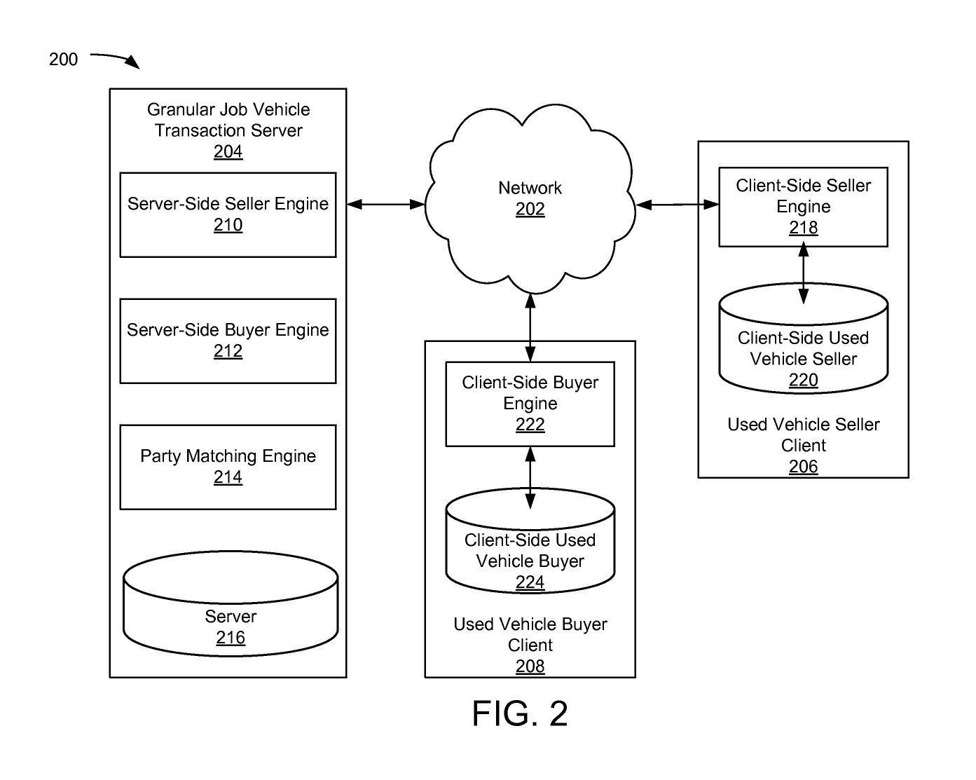

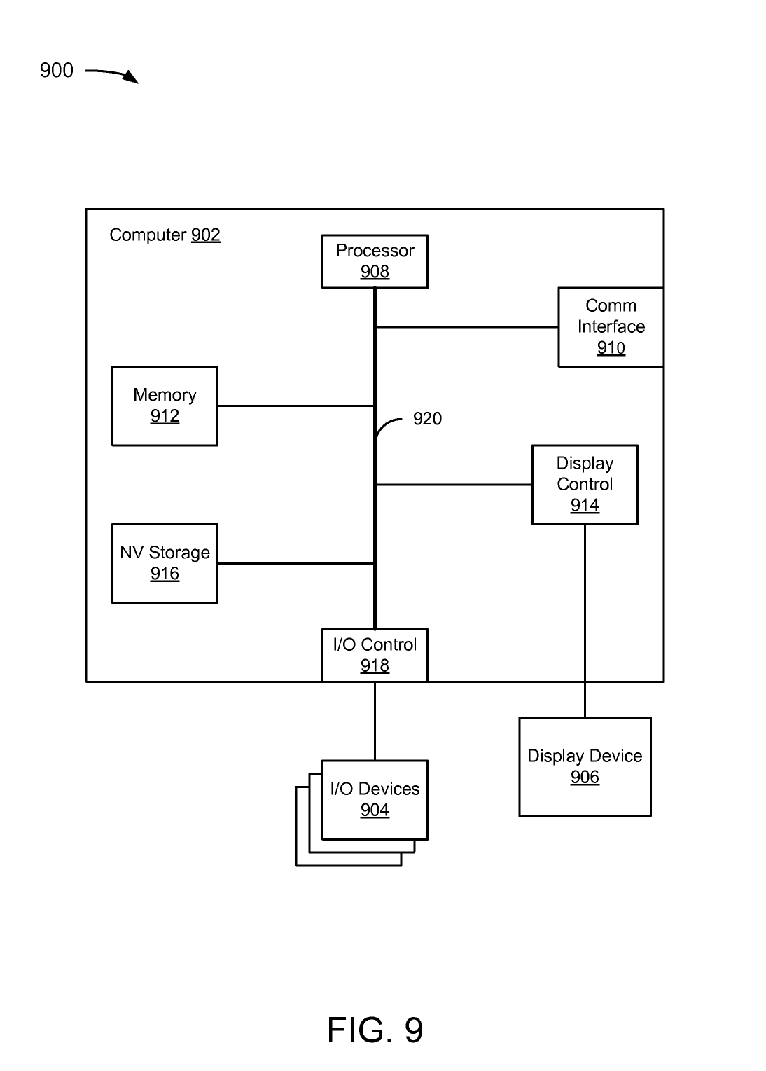

FIG. 2 shows an example of a granular job vehicle transaction system 200. In the example of FIG. 2, the granular job vehicle transaction system 200 includes a network 202, a granular job vehicle transaction server 204, a used vehicle seller client 206, and a used vehicle buyer client 208. In this example, some or all of the network 202, the granular job vehicle transaction server 204, the used vehicle seller client 206, and the used vehicle buyer client 208 may include hardware and/or software, and may take the form of a computer system, as shown in FIG. 9. In the example of FIG. 2, the vehicle transaction is carried out in accordance with job maps for one or more of the vehicle selling, vehicle buying, and vehicle buyer and seller match-making job executors. Accordingly, “granular job vehicle transaction” can be characterized as a “granular job” in the context of a “vehicle transaction.” In some embodiments, the context is that of a “used vehicle transaction,” implemented in a broader (e.g., used or new) vehicle transaction system.

In the example of FIG. 2, the network 202 can include an applicable computer-readable medium. The network 202 can facilitate communication between the devices in the granular vehicle transaction system 200. The network 202 can include a wireless network or a wired network, and can allow coupled devices to communicate over a variety of geographical ranges.

In the example of FIG. 2, the granular vehicle transaction server 204 can include engines and/or datastores configured to implement granular job frameworks to optimize used vehicle transactions for buyers and sellers. In this example, the granular vehicle transaction server 204 includes a server-side seller engine 210, a server-side buyer engine 212, a party matching engine 214, and a server datastore 216. It may be noted that the granular vehicle transaction server 204 need not be implemented to include the engines 210-214 on a single server, and instead could include a server or multiple servers dedicated to the buyer, a server or multiple servers dedicated to the seller, and/or a server or multiple servers dedicated to party matching, and the server datastore 216 may or may not be implemented as appropriate between the servers. Depending upon the capabilities of the system, the functionality described in association with the engines 210-214 could be executed at a server as illustrated, or could, in whole or in part, be executed on a client device or some other device that is owned by a job executor associated with a transaction.

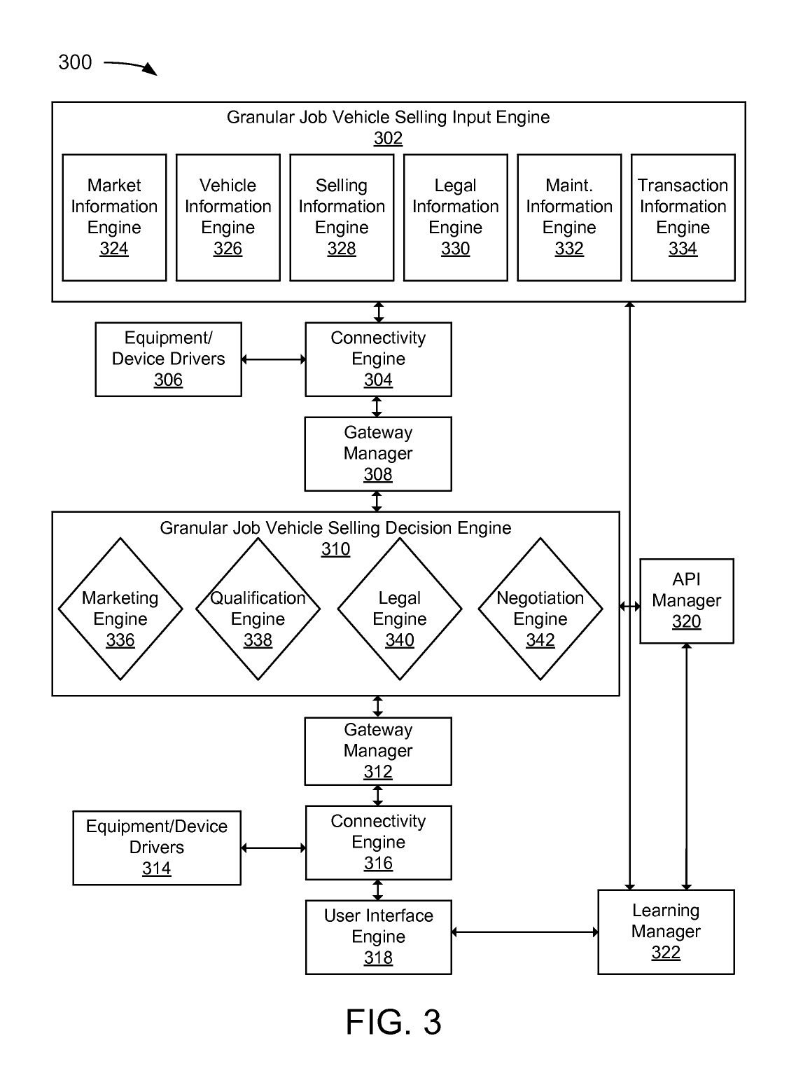

In the example of FIG. 2, the server-side seller engine 210 can be configured to implement a job map. The server-side seller engine 210 can include one or more of input engines, equipment and device drivers, connectivity engines, gateway managers, application programming interface (API) managers, decision engines, and learning managers. In some embodiments, the granular vehicle selling server engine 210 can interface with the server datastore 216. An example of a server-side seller engine 210 is discussed in conjunction with FIG. 3. It may be noted that some or all of the relevant functionality could alternatively be executed at a client or a device of a job executor associated with the relevant transaction.

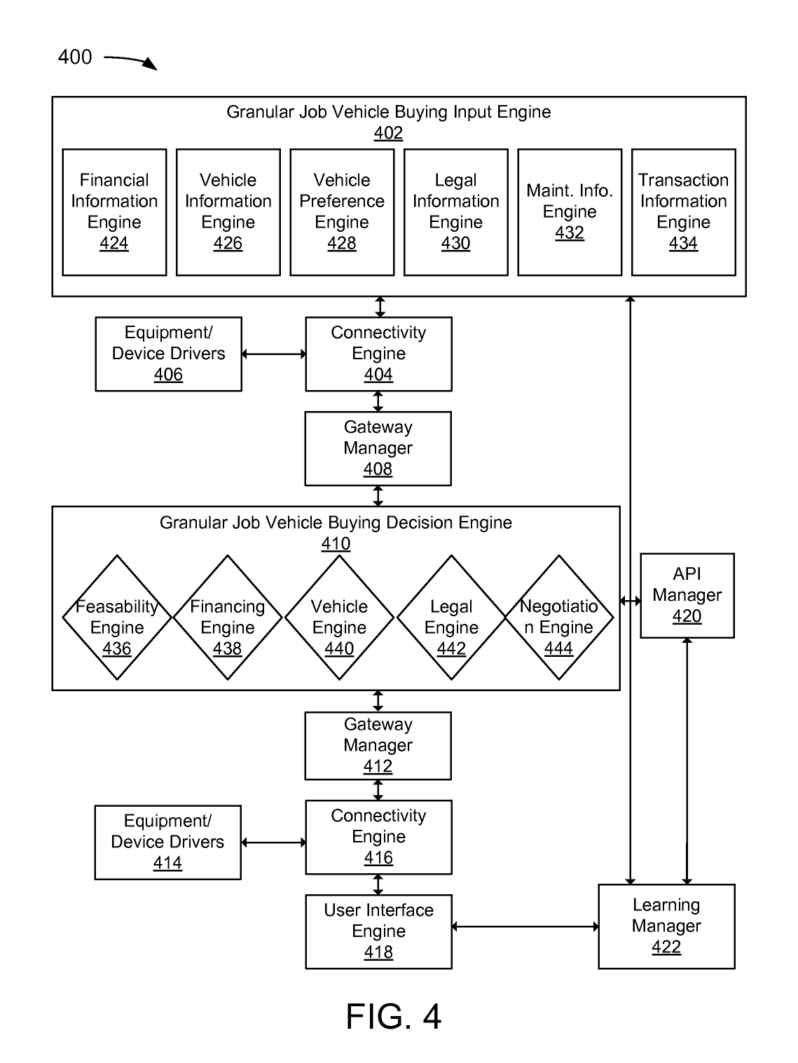

In the example of FIG. 2, the server-side buyer engine 212 can be configured to implement a job map. The server-side buyer engine 212 can include one or more of input engines, equipment and device drivers, connectivity engines, gateway managers, application programming interface (API) managers, decision engines, and learning managers. In some embodiments, the server-side buyer engine 212 can interface with the server datastore 216. An example of the server-side buyer engine 212 is discussed in conjunction with FIG. 4. It may be noted that some or all of the relevant functionality could alternatively be executed at a client or a device of a job executor associated with the relevant transaction.

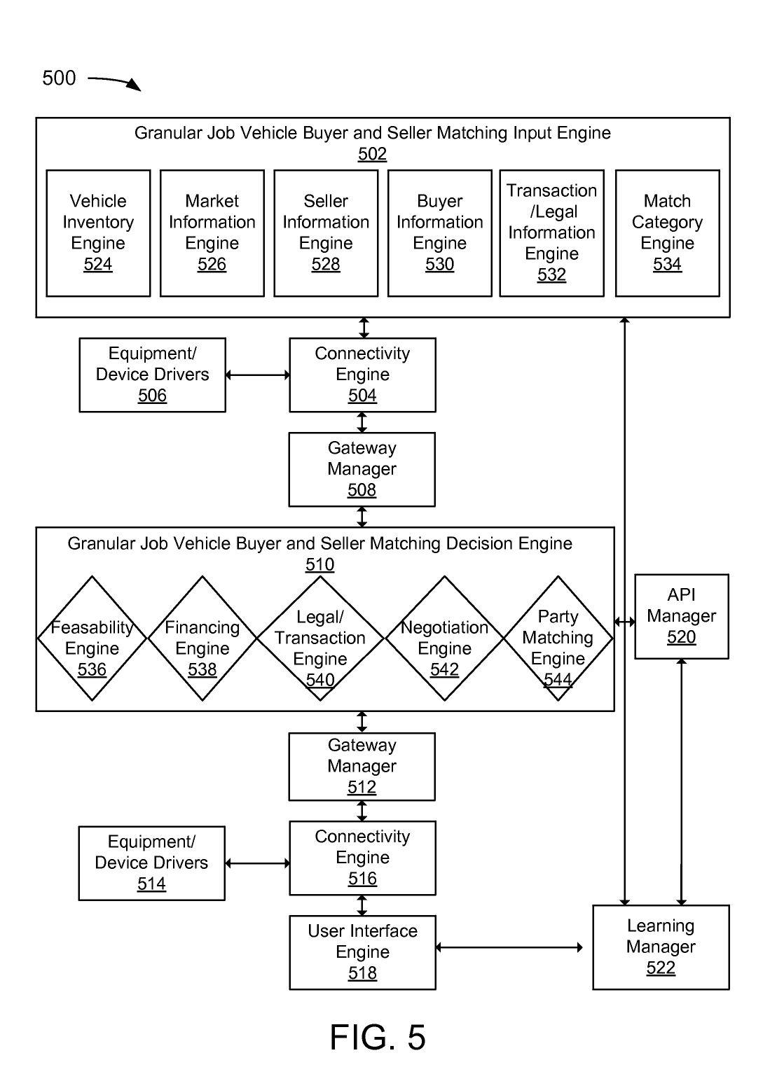

In the example of FIG. 2, the party matching engine 214 can be configured to implement a job map to match a used vehicle seller's incentives and interests with a used vehicle buyer's incentives and interests. The granular vehicle party matching engine 214 can include one or more of input engines, equipment and device drivers, connectivity engines, gateway managers, application programming interface (API) managers, decision engines, and learning managers. In some embodiments, the party matching engine 214 can interface with the server datastore 216. An example of the party matching engine 214 is discussed in conjunction with FIG. 5. It may be noted that some or all of the relevant functionality could alternatively be executed at a client or a device of a job executor associated with the relevant transaction.

In the example of FIG. 2, the server datastore 216 can be configured to store data related to one or more of the granular vehicle selling server engine 210, the granular vehicle buying server engine 212, and the granular vehicle party matching engine 214. The server datastore 216 can also store lists of specific vehicles and/or classes of vehicles, lists of buyers and/or sellers, sets of market models, market analytic data, sets of marketing models, and other data.

In the example of FIG. 2, the used vehicle seller client 206 can include engines and/or datastores configured to implement granular job frameworks to optimize a used vehicle seller's experience when seeking to enter into a used vehicle transaction. In some embodiments, the used vehicle seller client 206 can interface, via the network 202, with the used vehicle seller server engine 210. In the example of FIG. 2, the used vehicle seller client 206 can include a client-side buyer engine 218 and a client-side used vehicle seller datastore 220. In some embodiments, the used vehicle seller client 206 can reside on a seller's digital device, such as the seller's computer or mobile device.

In the example of FIG. 2, the client-side seller engine 218 can be configured to supply client side functionalities for a used vehicle seller. The client-side seller engine 218 can implement user interface engines processing engines, and other engines to facilitate access by a used vehicle seller to the granular vehicle selling server engine 210. In some embodiments, the client-side seller engine 218 can interface with the server-side seller engine 210 through a connection, e.g., via the network 202. Depending upon the implementation, the client-side seller engine 218 can include some or all of the functionality of a vehicle selling engine as described with reference to FIG. 3. In a specific implementation, the client-side seller engine 218 includes a browser or API that interfaces with a server-side engine where a job map is implemented. In such an implementation, the client-side seller engine 218 may serve as a relatively simple interface for data to be input to the server, where the job map is implemented, and for data to be provided to the seller.

In the example of FIG. 2, the client-side used vehicle seller datastore 220 can include data associated with granular job parameters for a seller. Such data may or may not be limited to data input by the seller (or an agent thereof) or downloaded to a device associated with the seller from a data source. In a specific implementation in which some or all of a granular job vehicle transaction engine is implemented at a server, the client-side used vehicle seller datastore 220 may or may not simply include temporary storage in hardware buffers as data is provided from the used vehicle seller client 206 to a server. In a specific implementation, data can be input via multiple different devices, potentially at multiple different times and potentially with a state tracker sufficient to inform a seller or agent thereof regarding the state of data entry, into the client-side used vehicle seller datastore 220.

In the example of FIG. 2, the used vehicle buyer client 208 can include engines and/or datastores configured to implement granular job frameworks to optimize a used vehicle buyer's experience when seeking to enter into a used vehicle transaction. In some embodiments, the used vehicle buyer client 208 can interface, via the network 202, with the server-side buyer engine 212. In the example of FIG. 2, the used vehicle buyer client 208 can include a client-side buyer engine 222 and a client-side used vehicle buyer datastore 224. In some embodiments, the used vehicle buyer client 208 can reside on buyer's digital device, such as the buyer's computer or mobile device.

In the example of FIG. 2, the client-side buyer engine 222 can be configured to supply client side functionalities for a used vehicle buyer. The client-side buyer engine 222 can implement user interface engines processing engines, and other engines to facilitate access by a used vehicle buyer to the server-side buyer engine 212. In some embodiments, the client-side buyer engine 222 can interface with the server-side buyer engine 212 through a connection, e.g., via the network 202. Depending upon the implementation, the client-side buyer engine 222 can include some or all of the functionality of a vehicle buying engine as described with reference to FIG. 4. In a specific implementation, the client-side buyer engine 222 includes a browser or API that interfaces with a server-side engine where a job map is implemented. In such an implementation, the client-side buyer engine 222 may serve as a relatively simple interface for data to be input to the server, where the job map is implemented, and for data to be provided to the seller.

In the example of FIG. 2, the client-side used vehicle buyer datastore 224 can include data associated with granular job parameters for a buyer. Such data may or may not be limited to data input by the buyer (or an agent thereof) or downloaded to a device associated with the buyer from a data source. In a specific implementation in which some or all of a granular job vehicle transaction engine is implemented at a server, the client-side used vehicle buyer datastore 224 may or may not simply include temporary storage in hardware buffers as data is provided from the used vehicle buyer client 208 to a server. In a specific implementation, data can be input via multiple different devices, potentially at multiple different times and potentially with a state tracker sufficient to inform a buyer or agent thereof regarding the state of data entry, into the client-side used vehicle buyer datastore 224.

FIG. 3 shows an example of a granular job vehicle selling engine 300. The granular job vehicle selling engine 300 can be configured to implement granular job frameworks to optimize a used vehicle seller's experience when seeking to enter into a used vehicle transaction. In the example of FIG. 3, the granular job vehicle selling engine 300 can include a granular job vehicle selling input engine 302, a connectivity engine 304, equipment/device drivers 306, a gateway manager 308, a granular selling decision engine 310, a gateway manager 312, equipment/device drivers 314, a connectivity engine 316, a user interface engine 318, an API manager 320, and a learning manager 322.

The granular job vehicle selling input engine 302 can be configured to provide other modules of the granular job vehicle selling engine 300 with information for implementing used vehicle sales-related jobs. The granular job vehicle selling input engine 302 can include one or more information engines. In this example, the granular vehicle selling input engine 302 can include a market information engine 324, a vehicle information engine 326, a selling information engine 328, a legal information engine 330, a maintenance information engine 332, and a transaction information engine 334. As used in this paper, an “information engine” is an engine that facilitates obtaining information for a larger system. A more detailed discussion of each of the market information engine 324, the vehicle information engine 326, the selling information engine 328, the legal information engine 330, the maintenance information engine 332, and the transaction information engine 334 can be found below.

In the example of FIG. 3, the market information engine 324 can be configured to supply market information to other modules of the granular job vehicle selling engine 300. As used herein, “market information” includes information relating to a general class of item, such as a class of a used vehicle that a user of the granular job vehicle selling engine 300 would like to offer for sale. Market information can relate to a make/model/year of a used vehicle, a likely quality or condition of the used vehicle based on data from similar vehicles, a geographic scope of a potential sale of the used vehicle, pricing information of similar models, estimates or actual accounts of supply, consumer demand data and/or other factors. The market information engine 324 can be configured, in various embodiments, to provide a market model and/or a marketing model for a given used vehicle for sale. In various embodiments, the market information engine 324 can retrieve the market information from a datastore coupled locally or remotely to the granular job vehicle selling engine 300.

In the example of FIG. 3, the vehicle information engine 326 can be configured to supply vehicle information to other modules of the granular job vehicle selling engine 300. As used herein, “vehicle information” includes information relating to a specific item, such as a specific used vehicle, that a party to a car transaction would like to offer for sale. Vehicle information can relate to a make/model/year of a specific used vehicle, mileage of the used vehicle, an accident history of the used vehicle, special information about the used vehicle (such as whether the used vehicle was the subject of an asset forfeiture), and other information. In some embodiments, the vehicle information engine 326 can also obtain maintenance or repair histories of a used vehicle, even though this information may also be used in the maintenance information engine 332 (as discussed below). In various embodiments, the vehicle information engine 326 can retrieve the vehicle information from a datastore coupled locally or remotely to the granular job vehicle selling engine 300.

In the example of FIG. 3, the selling information engine 328 can be configured to supply selling information to other modules of the granular vehicle selling engine 300. As used herein, “selling information” includes price-related data that a seller would like to have associated with a specific used vehicle to be offered for sale. To this end, the selling information engine 328 may contain a suggested sales price, suggested sales conditions such as financing conditions, and other conditions. In various embodiments, the selling information engine 328 can retrieve the selling information from a datastore coupled locally or remotely to the granular job vehicle selling engine 300.

In the example of FIG. 3, the legal information engine 330 can be configured to supply legal information to other modules of the granular job vehicle setting engine 300 so that a user of the granular job vehicle selling server engine 300 can affect a legal sale of a used vehicle offered for sale. As used herein, “legal information” includes information that would be useful to affect a legal sale of a used vehicle offered for sale. Legal information can relate to a seller's state/jurisdiction, contractual details such as forms and/or clauses that would underlie a sale, legal entities relating to the seller, and other information. In various embodiments, the legal information engine 330 can retrieve the legal information from a datastore coupled locally or remotely to the granular job vehicle selling engine 300.

In the example of FIG. 3, the maintenance information engine 332 can be configured to supply maintenance information to other modules of the granular job vehicle selling engine 300. As used herein, “maintenance information” includes maintenance and/or repair data related to a specific used vehicle to be offered for sale. In various embodiments, the maintenance information engine 332 can retrieve the maintenance information from a datastore coupled locally or remotely to the granular job vehicle selling engine 300.

In the example of FIG. 3, the transaction information engine 334 can be configured to supply transaction information to other modules of the granular job vehicle selling engine 300. As used herein, “transaction information” includes data that would be useful to complete a sale transaction of a used vehicle offered for sale. Transaction information can include contractual terms and conditions, delivery details, information relevant to transferring possession of the used vehicle, and other information. In various embodiments, the transaction information engine 334 can retrieve the transaction information from a datastore coupled locally or remotely to the granular vehicle selling server engine 300.

In the example of FIG. 3, the connectivity engine 304 can include a portion of a communication device, such as the Internet, or a device for coupling components of a single computer, such as a bus. In this example, the connectivity engine 304 can couple the granular job vehicle selling input engine 302 to the first equipment/device drivers 306 and the gateway manager 308.

In the example of FIG. 3, the first equipment/device drivers 306 can include equipment and/or drivers for connecting to other equipment related to the granular job vehicle selling engine 300. In some embodiments, the first equipment/device drivers 306 may couple the granular vehicle selling input engine 302 to one or more of a network location, a website, or storage to facilitate sending and retrieving information used by the granular vehicle selling input engine 302. In the example of FIG. 3, the gateway manager 308 can be configured as a communication gateway to facilitate communication between the connectivity engine 304 and the granular selling decision engine 310.

In the example of FIG. 3, the granular job vehicle selling decision engine 310 can be configured to implement decisions related to used vehicle sales-related jobs. The granular job vehicle selling decision engine 310 can include one or more decision engines. As used in this paper, a “decision engine” is an engine that facilitates reaching a decision based on rules and inputs provided to the decision engine. In this example, the granular job vehicle selling decision engine 310 can include a marketing engine 336, a qualification engine 338, a legal engine 340, and a negotiation engine 342.

In the example of FIG. 3, the marketing engine 336 can be configured to enable a seller to determine a market for vehicles similar to a used vehicle to be offered for sale. More specifically, the marketing engine 336 can allow the seller to enter similarity parameters to find vehicles similar to the used vehicle offered for sale. Examples of similarity parameters include makes/models/years of vehicles, vehicle classifications (e.g., compact vehicles, full-size vehicles, and trucks), car conditions, countries of a vehicle's origin, and other parameters. In a specific implementation, the marketing engine 336 can allow the seller to specify a geographical range and/or a time period for the relevant market. In some embodiments, the defined market can be temporary or have an expiry time after which the marketing engine 336 may prompt the seller for a clarification or redefinition of the relevant market. In the example of FIG. 3, the marketing engine 336 can be configured to list the used vehicle for sale in the seller-defined market. To this end, the marketing engine 336 can receive the vehicle information from the vehicle information engine 326, and can provide this vehicle information to the market information engine 324 or one or more datastores.

In the example of FIG. 3, the marketing engine 336 can be configured to ensure that the seller has prepared the used vehicle for sale. More specifically, the marketing engine 336 can receive vehicle information from the vehicle information engine 326. The marketing engine 336 can also receive maintenance information from the maintenance information engine 332. The received vehicle information and maintenance information can be verified against a predetermined list of items that are minimally required for a quality sale to occur. For instance, the marketing engine 336 can be configured to evaluate whether the used vehicle is in a running condition, and if not, can be configured to recommend repair to the seller before listing the car for sale. In some embodiments, the marketing engine 336 can ensure preparation for sale based on specialized information. For instance, the marketing engine 336 can be configured to ensure that a classic car to be listed for sale has stock or original parts.

In the example of FIG. 3, the marketing engine 336 can be configured to enable the seller to assess the market value of the used vehicle for sale. For instance, the marketing engine 336 can provide the market information and the marketing information from the market information engine 324 to the seller so that the seller can itself verify accurate measures of price of the used vehicle. The market value can be based on a market model from the market information engine 324. In the example of FIG. 3, the marketing engine 336 can enable the seller to determine an optimal pricing strategy for the sale of the used vehicle. The optimal pricing strategy may be based on the marketing model from the market information engine 324. In various embodiments, the optimal pricing strategy can be based on a desired seller-side price. As used in this paper, a “seller-side price” is a measure of value of a used vehicle that most closely aligns with the incentives of a seller in a used vehicle transaction. For instance, a seller-side price may include a price most favorable to the seller of the used vehicle for sale. The marketing engine 336 can also help a seller determine optimal methods and optimal messages to attract buyers. In various embodiments, the marketing engine 336 can use the marketing models from the market information engine 324 to determine optimal methods/messages.

In the example of FIG. 3, the qualification engine 338 can be configured to enable a seller to analyze potential buyers. For instance, the qualification engine 338 can be configured to evaluate information related to buyers. In various embodiments, evaluated information can include information such as financial information, demographic information, potential earnings information, geographic information, and other information of potential buyers. The qualification engine 338 can also be configured to qualify specific buyers based on a set of parameters. Relevant parameters include things such as a buyer's assets, a buyer's income over a duration of time, a buyer's ability to repay a loan, the likely loan amount a buyer may take, a buyer's location, a buyer's demographic group, and other parameters. The parameters may provide an estimate or an actual measure of a given buyer's ability to pay for the used vehicle for sale. In some embodiments, a seller can set the various parameters. In various embodiments, the parameters may be preset for the seller to select.

In the example of FIG. 3, the legal engine 340 enables the seller to execute required or desired legal documentation to execute a legal sale of the vehicle. The legal engine 340 can base the execution on the legal information stored in the legal information engine 330. The legal engine 340 can assist the seller obtain necessary contracts, including enforceable and binding sale contracts to ensure that a sale of the used vehicle is final. The legal engine 340 can also assist the seller interface with relevant state motor vehicle agencies to ensure that legal title to the used vehicle is properly transferred to a buyer.

In the example of FIG. 3, the negotiation engine 342 can enable a seller to enter into and conclude a negotiation with a buyer on the terms of a sale. In some embodiments, the negotiation engine 342 can operate based on transaction information from the transaction information engine 334. For instance, the negotiation engine 342 can obtain one or more of a variety of contractual terms to ensure the conditions of sale are favorable to the seller. In various embodiments, the negotiation engine 342 can include a seller-side checker to verify that the terms are indeed positive to the seller.

In the example of FIG. 3, the gateway manager 312 can be configured as a communication gateway to facilitate communication between the granular selling decision engine 310 and the connectivity engine 316. The connectivity engine 316 can include a portion of a communication device, such as the Internet, or a device for coupling components of a single computer, such as a bus.

In the example of FIG. 3, the equipment/device drivers 314 can include equipment and/or drivers for connecting to equipment related to the granular job vehicle selling engine 300. In some embodiments, the equipment/device drivers 314 may couple the granular job vehicle selling decision engine 310 to one or more of a network location, a website, or storage to facilitate sending and retrieving information used by the granular job vehicle selling decision engine 310.

In the example of FIG. 3, the user interface engine 318 can be configured to provide user interface tools to a user (e.g., a seller) using the granular job vehicle selling engine 300. To this end, the user interface engine 318 may supply a client device associated with the granular vehicle selling server engine 300 with the information required to display the implementation of granular job frameworks to optimize a used vehicle seller's experience when seeking to enter into a used vehicle transaction. Further, the API manager 320 can manage API calls required to support a computer program associated with the operations of the granular job vehicle selling engine 300.

In the example of FIG. 3, the learning manager 322 can be configured to learn selling patterns related to a seller associated with the granular job vehicle selling engine 300 to improve his or her selling patterns. The learning manager 322 can include a sales monitor to monitor the specific vehicles a seller has sold. The learning manager 322 can also include a preference monitor to evaluate a given seller's sales preferences and the types of sales that the seller is likely to have completed, as well as the terms of those sales. In some embodiments, the learning manager 322 can include a recommendation module configured to provide a seller with recommended prices, terms, conditions, and other information based on the seller's past sales. As shown in FIG. 3, the learning manager 322 can be coupled to one or more of the granular job vehicle selling input engine 302, the API manager 320, and the user interface engine 318.

FIG. 4 shows an example of a granular job vehicle buying engine 400. The granular job vehicle buying engine 400 can be configured to implement granular job frameworks to optimize a used vehicle buyer's experience when seeking to enter into a used vehicle transaction. In the example of FIG. 4, the granular job vehicle buying engine 400 can include a granular job vehicle buying input engine 402, a connectivity engine 404, equipment/device drivers 406, a gateway manager 408, a granular job vehicle buying decision engine 410, a gateway manager 412, equipment/device drivers 414, a connectivity engine 416, a user interface engine 418, an API manager 420, and a learning manager 422.

The granular job vehicle buying input engine 402 can be configured to provide other modules of the granular job vehicle buying engine 400 with information for implementing used vehicle purchase-related jobs. The granular job vehicle buying input engine 402 can include one or more information engines. In this example, the granular job vehicle buying input engine 402 can include a financial information engine 424, a vehicle information engine 426, a vehicle preference engine 428, a legal information engine 430, a maintenance information engine 432, and a transaction information engine 434. A more detailed discussion of each of the financial information engine 424, the vehicle information engine 426, the vehicle preference engine 428, the legal information engine 430, the maintenance information engine 432, and the transaction information engine 434 can be found below.

In the example of FIG. 4, the connectivity engine 404 can include a portion of a communication device, such as the Internet, or a device for coupling components of a single computer, such as a bus. In this example, the connectivity engine 404 can couple the granular job vehicle buying input engine 402 to the equipment/device drivers 406 and the gateway manager 408.

In the example of FIG. 4, the equipment/device drivers 406 can include equipment and/or drivers for connecting to other equipment related to the granular job vehicle buying engine 400. In some embodiments, the first equipment/device drivers 406 may couple the granular job vehicle buying input engine 402 to one or more of a network location, a website, or storage to facilitate sending and retrieving information used by the granular job vehicle buying input engine 402. In the example of FIG. 4, the gateway manager 408 can be configured as a communication gateway to facilitate communication between the connectivity engine 404 and the granular job vehicle buying decision engine 410.

In the example of FIG. 4, the granular job vehicle buying decision engine 410 can be configured to implement decisions related to used vehicle purchase-related jobs, i.e., jobs for a buyer of a used vehicle. The granular job vehicle buying decision engine 410 can include one or more decision engines. In this example, the granular job vehicle buying decision engine 410 can include a feasibility engine 436, a financing engine 438, a vehicle engine 440, a legal engine 442, and a negotiation engine 444. A more detailed discussion of each of the feasibility engine 436, the financing engine 438, the vehicle engine 440, the legal engine 442, and the negotiation engine 444 can be found below.

In the example of FIG. 4, the gateway manager 412 can be configured as a communication gateway to facilitate communication between the granular job vehicle buying decision engine 410 and the connectivity engine 416. The connectivity engine 416 can include a portion of a communication device, such as the Internet, or a device for coupling components of a single computer, such as a bus.

In the example of FIG. 4, the equipment/device drivers 414 can include equipment and/or drivers for connecting to equipment related to the granular job vehicle buying engine 400. In some embodiments, the equipment/device drivers 414 may couple the granular job vehicle buying decision engine 410 to one or more of a network location, a website, or storage to facilitate sending and retrieving information used by the granular job vehicle buying decision engine 410.

In the example of FIG. 4, the user interface engine 418 can be configured to provide user interface tools to a user (e.g., a buyer) using the granular job vehicle buying engine 400. To this end, the user interface engine 418 may supply a client device associated with the granular job vehicle buying engine 400 with the information required to display the implementation of granular job frameworks to optimize a used vehicle buyer's experience when seeking to enter into a used vehicle transaction. Further, the API Manager 420 can manage API calls required to support a computer program associated with the operations of the granular job vehicle buying engine 400.

In the example of FIG. 4, the learning manager 422 can be configured to learn purchase patterns related to a buyer associated with the granular job vehicle buying engine 400 to improve his or her selling patterns. The learning manager 422 can include a purchase monitor to monitor the specific vehicles a potential buyer has looked at, has purchased, or has desired. The learning manager 422 can also include a preference monitor to evaluate a given buyer's purchase preferences and the types of purchases that a person of the buyer's demographic or other group is likely to have completed, as well as the terms of those purchases. In some embodiments, the learning manager 422 can interface with analytics engines to review a buyer's web history or other past information and see the types of products the buyer is interested in or the demographic group to which the buyer belongs. In some embodiments, the learning manager 422 can include a recommendation module configured to provide a buyer with recommended prices, terms, conditions, and other information based on the buyer's past interests. As shown in FIG. 4, the learning manager 422 can be coupled to one or more of the granular job vehicle buying input engine 402, the API Manager 420, and the user interface engine 418.

In the example of FIG. 4, the financial information engine 424 can be configured to supply a buyer's financial information to other modules of the granular job vehicle buying engine 400. As used herein, “financial information” includes information relating to a buyer's pecuniary interests. Financial information can include things such as a buyer's assets, a buyer's income over a duration of time, a buyer's ability to repay a loan, the likely loan amount a buyer may take, a buyer's location, a buyer's demographic group, a buyer's tax rate, and other parameters. Financial information can relate to net assets or obligations of a buyer (e.g., a mortgage the buyer must repay). The financial information engine 424 can be configured, in various embodiments, to provide a financial summary of the buyer. In various embodiments, the financial information engine 424 can retrieve the financial information from a datastore coupled locally or remotely to the granular job vehicle buying engine 400.

In the example of FIG. 4, the vehicle information engine 426 can be configured to supply vehicle information to other modules of the granular job vehicle buying engine 400. The vehicle information from the vehicle information engine 426 may include the types of vehicles a buyer is interested in. In some embodiments, the vehicle information engine 426 can also store whether a buyer wishes to get a car with a specific maintenance or repair history (e.g., a car that has had all 30,000 mile checkups performed on it), even though this information may also reside in the maintenance information engine 432 (as discussed below). In various embodiments, the vehicle information engine 426 can retrieve the desired vehicle information from a datastore coupled locally or remotely to the granular job vehicle buying engine 400.

In the example of FIG. 4, the vehicle preference engine 428 can be configured to supply the buyer's vehicle preferences to other modules of the granular job vehicle buying engine 400. As used herein, “vehicle preferences” includes parameters of a vehicle that a buyer would find preferable but not necessarily desirable in making a purchase decision. Vehicle preferences include things such as minor scratches/dents, minor repair information, and other things a buyer may regard of little consequence in the ultimate purchase of a used vehicle. In various embodiments, the vehicle preference engine 428 can retrieve the selling information from a datastore coupled locally or remotely to the granular job vehicle buying engine 400.

In the example of FIG. 4, the legal information engine 430 can be configured to supply legal information to other modules so that a user of the granular job vehicle buying engine 400 can affect a legal sale of a used vehicle offered for sale. Legal information can relate to a buyer's state/jurisdiction, contractual details such as forms and/or clauses that would underlie a sale, legal entities relating to the buyer, and other information. In various embodiments, the legal information engine 430 can retrieve the legal information from a datastore coupled locally or remotely to the granular job vehicle buying engine 400.

In the example of FIG. 4, the maintenance information engine 432 can be configured to supply desired maintenance information to the other modules in the granular job vehicle buying engine 400. In various embodiments, the maintenance information engine 332 can retrieve the maintenance information from a datastore coupled locally or remotely to the granular job vehicle buying engine 400.

In the example of FIG. 4, the transaction information engine 434 can be configured to supply transaction information to other modules of the granular job vehicle buying engine 400. Transaction information can include contractual terms and conditions, delivery details, information relevant to transferring possession of the used vehicle, and other information. In various embodiments, the transaction information engine 434 can retrieve the transaction information from a datastore coupled locally or remotely to the granular job vehicle buying engine 400.

In the example of FIG. 4, the feasibility engine 436 can be configured to enable a buyer to determine information required for the purchase of a given used vehicle. For instance, based on the buyer's financial information from the financial information engine 424 and the vehicle information from the vehicle information engine 426, the feasibility engine 436 can determine feasibility parameters such as legal ability to buy a vehicle, minimum loan qualifications, minimum down payments required, minimum credit ratings, minimum delivery and geographic requirements, and other qualifications for the purchase of a used vehicle. The feasibility engine 436 can also provide a recommendation whether the buyer meets the minimum qualifications (i.e., whether the buyer's purchase is feasible) for a given class of used vehicles. In some embodiments, the feasibility engine 436 can help a buyer define a relevant market and can assist the user in finding a used vehicle for sale in that market. For instance, the feasibility engine 436 can allow the buyer to enter similarity parameters for cars similar to a desired class of car. As discussed, examples of similarity parameters include makes/models/years of cars, car classifications (e.g., compact cars, full-size cars, and trucks), car conditions, countries of a car's origin, and other parameters. The feasibility engine 436 can also allow the buyer to specify a geographical range and/or a time period for the relevant market. In some embodiments, the defined market can be temporary or have an expiry time. In various embodiments, the feasibility engine 436 can also receive a buyer's inputs about a desired vehicle and can enable the buyer to assess the market value of the desired vehicle for purchase.

In the example of FIG. 4, the financing engine 438 can enable a buyer to analyze potential financing options. For instance, the financing engine 438 can obtain one or more financing plans from a datastore (remotely or locally) and can provide the financing plans to the buyer. In some embodiments, the financing engine 438 can qualify the buyer for the financing options based on a set of parameters such as the terms of a loan to purchase a used vehicle. For example, the financing engine 438 can compare the financial information from the financial information engine 424 to determine whether the buyer qualifies for a given financing plan. In various embodiments, the financing engine 438 can recommend an optimal financing plan based on the buyer's financial information.

In the example of FIG. 4, the vehicle engine 440 can be configured to accept a desired vehicle for purchase by the buyer. In some embodiments, the vehicle engine 440 can be configured to accept a class of vehicles. In some embodiments, the vehicle engine 440 can validate one or more of vehicle safety, an aesthetic quality of the vehicle, and vehicle handling. The vehicle engine 440 can also be configured to determine maintenance costs for the vehicle.

In the example of FIG. 4, the legal engine 442 enables the buyer to execute required or desired legal documentation to execute a legal sale of the vehicle. The legal engine 442 can base the execution on the legal information stored in the legal information engine 430. The legal engine 442 can assist the seller obtain necessary contracts, including enforceable and binding sale contracts to ensure that a sale of the used vehicle is final. The legal engine 442 can also assist the buyer interface with relevant state motor vehicle agencies to ensure that legal title to the used vehicle is properly transferred from the seller to a buyer.

In the example of FIG. 4, the negotiation engine 444 can enable a buyer to enter into and conclude a negotiation with a seller on the terms of a sale. In some embodiments, the negotiation engine 444 can operate based on transaction information from the transaction information engine 434. For instance, the negotiation engine 444 can obtain one or more of a variety of contractual terms to ensure the conditions of sale are favorable to the buyer. In various embodiments, the negotiation engine 444 can include a buyer-side checker to verify that the terms are indeed positive to the buyer.

FIG. 5 shows an example of a granular job vehicle party matching engine 500. The granular job vehicle party matching engine 500 can be configured to implement granular job frameworks to optimize a matching a used vehicle seller with a user car buyer. In the example of FIG. 5, the granular job vehicle party matching engine 500 can include a granular job vehicle buyer and seller matching input engine 502, a connectivity engine 504, equipment/device drivers 506, a gateway manager 508, a granular job vehicle buyer and seller matching decision engine 510, a gateway manager 512, equipment/device drivers 514, a connectivity engine 516, a user interface engine 518, an API manager 520, and a learning manager 522.

The granular job vehicle buyer and seller matching input engine 502 can be configured to provide other modules of the granular job vehicle party matching engine 500 with information for implementing used vehicle purchase-related jobs. The granular job vehicle buyer and seller matching input engine 502 can include one or more information engines. In this example, the granular job vehicle buyer and seller matching input engine 502 can include a vehicle inventory engine 524, a market information engine 526, a seller information engine 528, a buyer information engine 530, a transaction/legal information engine 532, and a match category engine 534. A more detailed discussion of each of the vehicle inventory engine 524, the market information engine 526, the seller information engine 528, the buyer information engine 530, the transaction/legal information engine 532, and the match category engine 534 can be found below.

In the example of FIG. 5, the connectivity engine 504 can include a portion of a communication device, such as the Internet, or a device for coupling components of a single computer, such as a bus. In this example, the connectivity engine 504 can couple the granular job vehicle buyer and seller matching input engine 502 to the equipment/device drivers 506 and the gateway manager 508.

In the example of FIG. 5, the equipment/device drivers 506 can include equipment and/or drivers for connecting to other equipment related to the granular job vehicle party matching engine 500. In some embodiments, the equipment/device drivers 506 may couple the granular job vehicle buyer and seller matching input engine 502 to one or more of a network location, a website, or storage to facilitate sending and retrieving information used by the granular job vehicle buyer and seller matching input engine 502. In the example of FIG. 5, the gateway manager 508 can be configured as a communication gateway to facilitate communication between the connectivity engine 504 and the granular job vehicle buyer and seller matching decision engine 510.

In the example of FIG. 5, the granular job vehicle buyer and seller matching decision engine 510 can be configured to implement decisions related to used vehicle buyer-seller matching jobs, i.e., jobs to match a seller of a used vehicle with a buyer of a used vehicle. The granular job vehicle buyer and seller matching decision engine 510 can include one or more decision engines. In this example, the granular job vehicle buyer and seller matching decision engine 510 can include a feasibility engine 536, a financing engine 538, a legal/transaction engine 540, a negotiation engine 542, and a party matching engine 544. A more detailed discussion of each of the feasibility engine 536, the financing engine 538, the legal/transaction engine 540, the negotiation engine 542, and the party matching engine 544 can be found below.

In the example of FIG. 5, the gateway manager 512 can be configured as a communication gateway to facilitate communication between the granular job vehicle buyer and seller matching decision engine 510 and the connectivity engine 516. The connectivity engine 516 can include a portion of a communication device, such as the Internet, or a device for coupling components of a single computer, such as a bus.

In the example of FIG. 5, the equipment/device drivers 514 can include equipment and/or drivers for connecting to equipment related to the granular job vehicle party matching engine 500. In some embodiments, the equipment/device drivers 514 may couple the granular job vehicle buyer and seller matching decision engine 510 to one or more of a network location, a website, or storage to facilitate sending and retrieving information used by the granular job vehicle buyer and seller matching decision engine 510.

In the example of FIG. 5, the user interface engine 518 can be configured to provide user interface tools to a user (e.g., one or more of a buyer and a seller) using the granular job vehicle party matching engine 500. To this end, the user interface engine 518 may supply a client device associated with the granular job vehicle party matching engine 500 with the information required to display the implementation of granular job frameworks to optimize the experiences of a used vehicle buyers and sellers when seeking to enter sell used vehicle. Further, the API manager 520 can manage API calls required to support a computer program associated with the operations of the granular job vehicle party matching engine 500.

In the example of FIG. 5, the learning manager 522 can be configured to learn bargaining, sales, and/or purchase patterns related to buyers and/or sellers associated with the granular job vehicle party matching engine 500. The learning manager 522 can help improve matching, sales, and/or purchases. The learning manager 522 can include a bargaining monitor to monitor the specific ways parties have bargained with one another in the past to provide a future estimate of a price. The learning manager 522 can also evaluate the specific vehicles a potential buyer has looked at, has purchased, or has desired. The learning manager 522 can also include a preference monitor to evaluate a given buyer's purchase preferences and the types of purchases that a person of the buyer's demographic or other group is likely to have completed, as well as the terms of those purchases. In some embodiments, the learning manager 522 can interface with analytics engines to review a buyer's web history or other past information and see the types of products the buyer is interested in or the demographic group to which the buyer belongs. In some embodiments, the learning manager 522 can include a recommendation module configured to provide a buyer with recommended prices, terms, conditions, and other information based on the buyer's past interests. In some embodiments, the learning manager 522 can also evaluate a given seller's sales preferences and the types of sales that the seller is likely to have completed, as well as the terms of those sales. In some embodiments, the learning manager 522 can include a recommendation module configured to provide a seller with recommended prices, terms, conditions, and other information based on the seller's past sales. As shown in FIG. 5, the learning manager 522 can be coupled to one or more of the granular job vehicle buyer and seller matching input engine 502, the API manager 520, and the user interface engine 518.

In the example of FIG. 5, the vehicle inventory engine 524 can be configured to supply an inventory of vehicles that are potentially for sale between a set of buyers and a set of sellers. The vehicle inventory can be limited by geographic location, time, price range, or available financing options. In various embodiments, the vehicle inventory engine 524 can retrieve the vehicle from a datastore coupled locally or remotely to the granular job vehicle party matching engine 500.

In the example of FIG. 5, the market information engine 526 can be configured to supply market information to the other modules in the granular job vehicle party matching engine 500. Relevant market information can relate to a make/model/year of a used vehicle, a likely quality or condition of the used vehicle based on data from similar vehicles, a geographic scope of a potential sale of the used vehicle, pricing information of similar models, estimates or actual accounts of supply, consumer demand data and/or other factors. The market information engine 526 can be configured, in various embodiments, to provide a market model and/or a marketing model for a given used vehicle for sale. In various embodiments, the market information engine 526 can retrieve the market information from a datastore coupled locally or remotely to the granular job vehicle party matching engine 500.

In the example of FIG. 5, the seller information engine 528 can be configured to supply seller information to the other modules in the granular job vehicle party matching engine 500. As used herein, “seller information” includes identifies of sellers, as well as price-related data that a seller would like to have associated with a specific used vehicle to be offered for sale. To this end, the seller information engine 528 may contain suggested sales prices, suggested sales conditions such as financing conditions, and other conditions; the prices and conditions may be associated with each of a plurality of sellers of used vehicles. In various embodiments, the seller information engine 528 can retrieve the seller information from a datastore coupled locally or remotely to the granular job vehicle party matching engine 500.

In the example of FIG. 5, the buyer information engine 530 can be configured to supply buyer information to the other modules in the granular job vehicle party matching engine 500. As used herein, “buyer information” includes identities of potential buyers, financial information of potential buyers, demographic, socio-economic and other information related to potential buyers, and/or feasibility information related to potential buyers. Buyer information may also include vehicle information and vehicle preference information of buyers or groups of buyers. In various embodiments, the buyer information engine 530 can retrieve the buyer information from a datastore coupled locally or remotely to the granular job vehicle party matching engine 500.

In the example of FIG. 5, the transaction/legal information engine 532 can be configured to supply transaction information to the other modules in the granular job vehicle party matching engine 500. Transaction information can include contractual terms and conditions, delivery details, information relevant to transferring possession of the used vehicle, and other information. The transaction/legal information engine 532 can also be configured to legal information to the other modules so that a user of the granular job vehicle party matching engine 500 can affect a legal sale of a used vehicle offered for sale. Legal information can relate to a prospective buyer and/or seller's state/jurisdiction, contractual details such as forms and/or clauses that would underlie a sale, legal entities relating to prospective buyers and/or sellers, and other information. In various embodiments, the transaction/legal information engine 532 can retrieve the transaction and/or legal information from a datastore coupled locally or remotely to the granular job vehicle party matching engine 500.

In the example of FIG. 5, the match category engine 534 can be configured to identify an extent to which a prospective buyer's interests and/or incentives match with a prospective seller's interests and/or incentives. In some embodiments, the match category engine 534 may assign one or more categories to groups of prospective buyers and/or sellers depending on the extent the interests of these parties correlate with one another. In various embodiments, the match category engine 534 can base the categories on buyer information from the buyer information engine 530 and/or datastores, as well as seller information from the seller information engine 528 and/or datastores. The datastores can be coupled locally or remotely to the granular job vehicle party matching engine 500.

In the example of FIG. 5, the feasibility engine 536 can be configured to determine whether one or more prospective buyers have the minimum qualifications to purchase one or more used vehicles at issue. For instance, based on the buyer's information from the buyer information engine 530 and vehicle information from the vehicle inventory engine 524, the feasibility engine 536 can determine feasibility parameters such as minimum loan qualifications, minimum down payments required, minimum credit ratings, minimum delivery and geographic requirements, and other qualifications for the purchase of a used vehicle. The feasibility engine 536 can also provide a recommendation whether a given the buyer meets the minimum qualifications (i.e., whether the buyer's purchase is feasible) for a given class of used vehicles. In some embodiments, the feasibility engine 536 can set minimum qualifications to be communicated to other engines, such as the party matching engine 544. The qualifications may depend on a relevant market. For instance, the feasibility engine 536 can address similarity parameters for vehicles similar to a desired class of vehicle. As discussed, examples of similarity parameters include makes/models/years of vehicles, vehicle classifications (e.g., compact cars, full-size cars, and trucks), vehicle conditions, countries of a vehicle's origin, and other parameters. The feasibility engine 536 can also specify a geographical range and/or a time period for the relevant market. In some embodiments, the defined market can be temporary or have an expiry time. In various embodiments, the feasibility engine 536 can also receive a buyer's inputs about a desired vehicle. The feasibility engine 536 can assign feasibility categories to buyers and can communicate the feasibility categories to other modules such as the party matching engine 544.

In the example of FIG. 5, the financing engine 538 can determine potential buyers' financing desires from the buyer information taken from the buyer information engine 530. The financing engine 538 can also determine potential sellers' financing desires from seller information taken from the seller information engine 528. The financing engine 538 can assign financing categories to buyers and can communicate the feasibility categories to other modules such as the party matching engine 544.

In the example of FIG. 5, the legal/transaction engine 540 can be configured to enable the prospective buyer and/or sellers to execute required or desired legal documentation to execute a legal sale of prospective vehicles. The legal/transaction engine 540 can base the execution on the legal information stored in one or more of the seller information engine 528 (regarding sellers) and the buyer information engine 530 (regarding buyers). The legal/transaction engine 540 can assist the parties to potential transactions obtain necessary contracts, including enforceable and binding sale contracts to ensure that a sale of the used vehicle is final. The legal/transaction engine 540 can also assist the parties interface with relevant state motor vehicle agencies to ensure that legal title to the used vehicle is properly transferred from the seller to a buyer.

In the example of FIG. 5, the party matching engine 544 can be configured to match a prospective buyer to a prospective seller. In various embodiments, the matching can be based on the extent the preferences and desires of a prospective buyer match the preferences and desires of a prospective buyer. Accordingly, various embodiments can match sellers with buyers and hold the parties' hands through a used vehicle transaction.

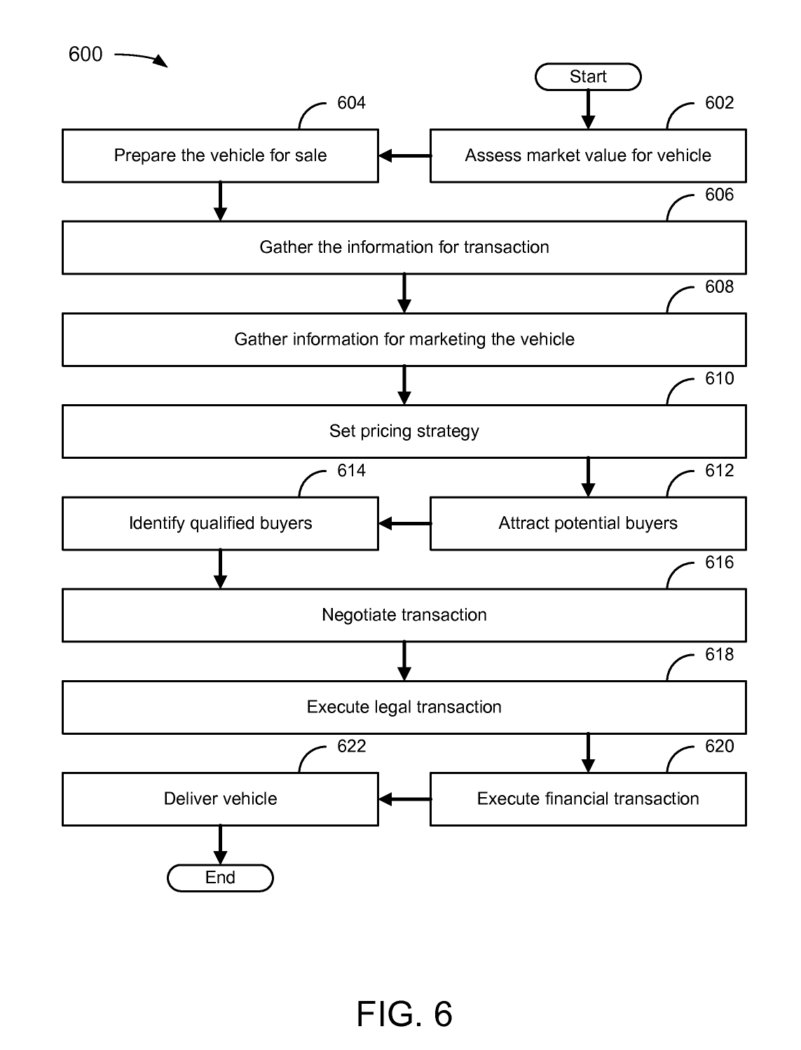

FIG. 6 shows an example of a method 600 for executing a job map for selling a vehicle. The method 600 will be discussed in conjunction with the elements of the granular vehicle selling server engine 300 in FIG. 3. In module 602, the marketing engine 336 can assess a market value for a vehicle based on market information from the market information engine 324 and vehicle information from the vehicle information engine 326. In module 604, the marketing engine 336 can be configured to ensure that the seller has prepared the used vehicle for sale. In module 606, the negotiation engine 342 can gather transaction information from the transaction information engine 334 for a used vehicle sale transaction. In module 608, the marketing engine 336 can gather marketing information, optionally in the form of a marketing model, from the market information engine 324. In module 610, marketing engine 336 can set a pricing strategy, optionally based on the market model and/or the marketing model. In module 612, the marketing engine 336 can attract potential buyers, optionally based on the marketing model from the market information engine 324. In module 614, the qualification engine 338 can be configured to identify qualified buyers based on buyers who meet qualifications for vehicle purchase. In module 616, the negotiation engine 342 can negotiate a transaction based on information from the transaction information engine 334. In module 618, the legal engine 340 can execute a legal transaction for the sale of a given used vehicle. In module 620, the first equipment/device drivers 306 and/or the second equipment/device drivers 314 can execute the financial transaction for the purchase of the used vehicle. In module 622, the first equipment/device drivers 306 and/or the second equipment/device drivers 314 can arrange for delivery of the purchased vehicle.

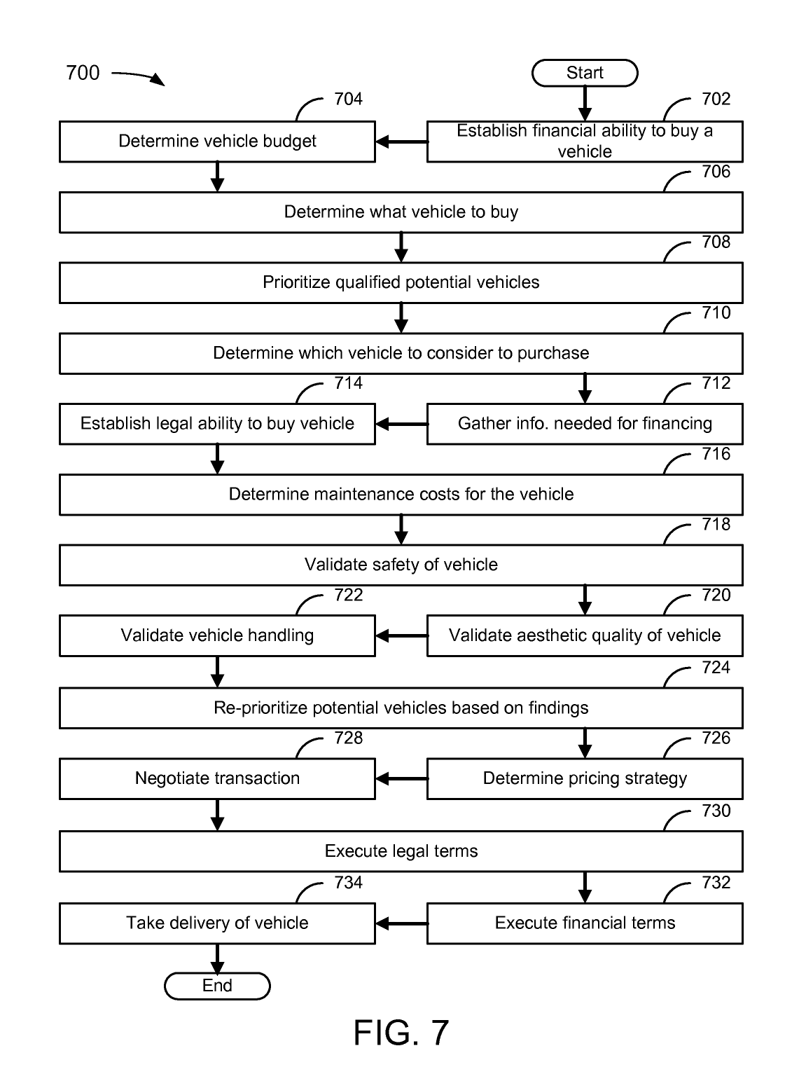

FIG. 7 shows an example of a method 700 for executing a job map for buying a vehicle. The method 700 will be discussed in conjunction with the granular vehicle buying server engine 400 in FIG. 4. In module 702, the feasibility engine 436 can determine financial ability to buy a vehicle. In module 704, the feasibility engine 436 can determine a vehicle budget for the buyer. In module 706, the feasibility engine 436 can determine, optionally based on input from the buyer, what vehicle to buy. In module 708, the feasibility engine 436 can prioritize qualified vehicles for a buyer. In module 710, the feasibility engine 436 can determine what vehicles to consider for purchase. In module 712, the financing engine 438 can gather the information needed for financing. In module 714, the feasibility engine 436 can determine a purchaser's legal ability to buy a vehicle. In module 716, the vehicle engine 440 can be configured to determine maintenance costs for the vehicle. In module 718, the vehicle engine 440 can validate the safety of the vehicle. In module 720, the vehicle engine 440 can validate the aesthetic quality of the vehicle. In module 722, the vehicle engine 440 can validate the handling of the vehicle. In module 724, the feasibility engine 436 can reprioritize the vehicles based on the findings from the vehicle engine 440. In module 726, the feasibility engine 436 can be configured to determine a pricing strategy, optionally based on a market model. In module 728, the negotiation engine 444 can negotiate a transaction. In module 730, the legal engine 442 can execute the legal terms of the sale. In module 732, the negotiation engine 444 can execute the financial terms of the transaction. In module 734, the first equipment/device drivers 406 and/or the second equipment/device drivers 414 can arrange for delivery of the purchased vehicle.

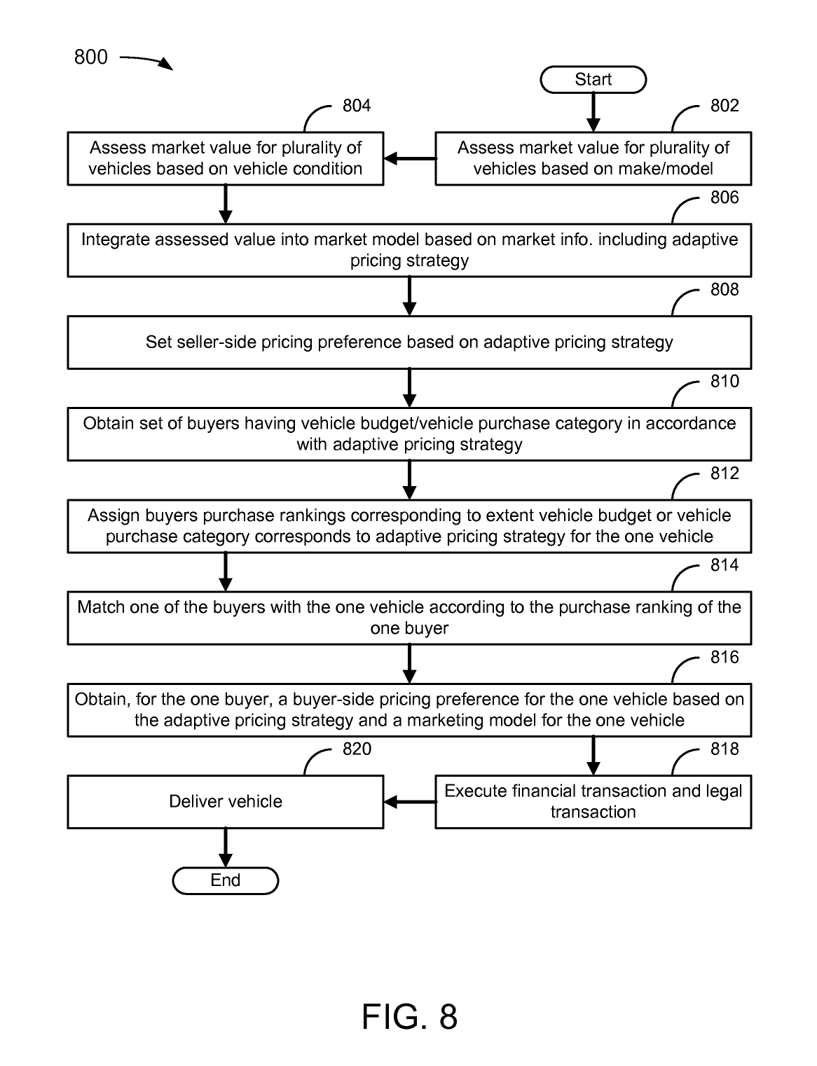

FIG. 8 shows an example of a method 800 for executing a job map for matching a vehicle buyer and vehicle seller. The method 800 will be discussed in conjunction with the granular job vehicle party matching engine 500 in FIG. 5. In module 802, the feasibility engine assesses a market value for a plurality of vehicles based on their makes/models; optionally the market value is based on a market model. In module 804, the feasibility engine 536 assesses a market value of for the plurality of vehicles based on their conditions; optionally the market value is based on a market model. In module 806, the negotiation engine 542 integrates the assessed value into the market model based on market information that includes an adaptive pricing strategy. In module 808, the negotiation engine 542 sets a seller-side pricing preference based on the adaptive pricing strategy. In module 810, the feasibility engine 536 obtains a set of buyers having vehicle budgets or vehicle purchase categories in accordance with the adaptive pricing strategy. In module 812, the negotiation engine 542 assigns the buyers purchase rankings corresponding to the extent the vehicle budgets or vehicle purchase categories correspond to the adaptive pricing strategies for the one vehicle. In module 814, the party matching engine 544 matches one of the buyers with the one vehicle according to the purchase ranking of the one buyer. In module 816, the party matching engine, in conjunction with the negotiation engine 542, obtains, for the one buyer, a buyer-side pricing preference for the one vehicle based on the adaptive pricing strategy and the marketing model for the one vehicle. In module 818, the legal/transaction engine 540 executes the legal and financial transactions. In module 820, the first equipment/device drivers 506 and/or the second equipment/device drivers 514 can arrange for delivery of the purchased vehicle.

FIG. 9 shows an example of a computer system 900. In the example of FIG. 9, the computer system 900 can be a conventional computer system that can be used as a client computer system, such as a wireless client or a workstation, or a server computer system. The computer system 900 includes a computer 902, I/O devices 904, and a display device 906. The computer 902 includes a processor 908, a communications interface 910, memory 912, display controller 914, non-volatile storage 916, and I/O controller 918. The computer 902 may be coupled to or include the I/O devices 904 and display device 906.

In the example of FIG. 9, the computer 902 interfaces to external systems through the communications interface 910, which may include a modem or network interface. It will be appreciated that the communications interface 910 can be considered to be part of the computer system 900 or a part of the computer 902. The communications interface 910 can be an analog modem, ISDN modem, cable modem, token ring interface, satellite transmission interface (e.g. “direct PC”), or other interfaces for coupling a computer system to other computer systems.

In the example of FIG. 9, the processor 908 may be, for example, a conventional microprocessor such as an Intel Pentium microprocessor or Motorola power PC microprocessor. The memory 912 is coupled to the processor 908 by a bus 920. The memory 912 can be Dynamic Random Access Memory (DRAM) and can also include Static RAM (SRAM). The bus 920 couples the processor 908 to the memory 912, also to the non-volatile storage 916, to the display controller 914, and to the I/O controller 918.

In the example of FIG. 9, the I/O devices 904 can include a keyboard, disk drives, printers, a scanner, and other input and output devices, including a mouse or other pointing device. The display controller 914 may control in the conventional manner a display on the display device 906, which can be, for example, a cathode ray tube (CRT) or liquid crystal display (LCD). The display controller 914 and the I/O controller 918 can be implemented with conventional well known technology.

In the example of FIG. 9, the non-volatile storage 916 is often a magnetic hard disk, an optical disk, or another form of storage for large amounts of data. Some of this data is often written, by a direct memory access process, into memory 912 during execution of software in the computer 902. One of skill in the art will immediately recognize that the terms “machine-readable medium” or “computer-readable medium” includes any type of storage device that is accessible by the processor 908 and also encompasses a carrier wave that encodes a data signal.

In the example of FIG. 9, the computer system 900 is one example of many possible computer systems which have different architectures. For example, personal computers based on an Intel microprocessor often have multiple buses, one of which can be an I/O bus for the peripherals and one that directly connects the processor 908 and the memory 912 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 912 for execution by the processor 908. A Web TV system, which is known in the art, is also considered to be a computer system, but it may lack some of the features shown in FIG. 9, such as certain input or output devices. A typical computer system will usually include at least a processor, memory, and a bus coupling the memory to the processor.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Techniques described in this paper relate to apparatus for performing the operations. The apparatus can be specially constructed for the required purposes, or it can comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus.

We claim:

1. A method, comprising:
identifying a vehicle for sale by a seller;
assessing a market value of the identified vehicle based on one or more of a condition, a make, and a model of the identified vehicle;
integrating the assessed market value of the identified vehicle into a market model based on market information related to the make and the model of the identified vehicle, the market model including an adaptive pricing strategy;
setting a seller-side price for the identified vehicle based on the adaptive pricing strategy;
building a marketing model of the identified vehicle based on the adaptive pricing strategy;
attracting a set of potential buyers based on the marketing model;
receiving buyer-related information about each of the set of potential buyers;
identifying one or more qualified buyers from the set of potential buyers based on the buyer-related information of the one or more qualified buyers;
facilitating a sale of the vehicle from the seller to at least one of the one or more qualified buyers.

2. The method of claim 1, wherein facilitating the sale of the identified vehicle comprises:
receiving a bid for the identified vehicle from the one qualified buyer;
facilitating acceptance of the bid by the seller.

3. The method of claim 1, wherein facilitating the sale of the identified vehicle comprises:
facilitating legal transfer of the identified vehicle from the seller to the one qualified buyer;
facilitating payment for the identified vehicle from the one qualified buyer to the seller.

4. The method of claim 1, wherein facilitating the sale of the identified vehicle comprises:
providing a set of instructions to the seller to physically prepare the vehicle for delivery to the one qualified buyer;
coordinating the delivery of the vehicle from the seller to the one qualified buyer.

5. A method, comprising:
receiving financial information and vehicle preference information from a potential buyer;
assigning a vehicle budget to the potential buyer based on one or more of the financial information and the vehicle preference information;
assigning a vehicle purchase category to the potential buyer based on one or more of the financial information and the vehicle preference information;
providing to the potential buyer a set of vehicles for sale based on the vehicle budget and the vehicle purchase category;
receiving a selection of one of the set of vehicles;
updating a market model for the selected vehicle, the market model based on market information related to a make and a model of the selected vehicle, the market model including an adaptive pricing strategy;
setting a buyer-side price for the selected vehicle, the buyer-side price based on the adaptive pricing strategy and a marketing model for the selected vehicle;
facilitating a sale of the selected vehicle from the seller to the potential buyer.

6. The method of claim 5, further comprising:
calculating maintenance costs for the selected vehicle;
validating one or more of: a safety rating, an aesthetic quality, and a vehicle handling rating of the selected vehicle.

7. The method of claim 5, wherein facilitating the sale of the selected vehicle comprises:
receiving a bid for the selected vehicle from the potential buyer;
facilitating acceptance of the bid by the seller.

8. The method of claim 5, wherein facilitating the sale of the selected vehicle comprises:
facilitating legal transfer of the selected vehicle from the seller to the potential buyer;
facilitating payment for the selected vehicle from the potential buyer to the seller.

9. The method of claim 5, wherein facilitating the sale of the selected vehicle comprises:
providing a set of instructions to the seller to physically prepare the vehicle for delivery to the potential buyer;
coordinating the delivery of the vehicle from the seller to the potential buyer.

10. The method of claim 5, wherein facilitating the sale of the selected vehicle comprises:
prioritizing the one or more vehicles based on the vehicle budget and the vehicle preference information;
re-prioritizing potential vehicles based on a match between the adaptive pricing strategy and one or more of the vehicle budget and the vehicle preference information.

11. A method, comprising:
assessing a market value of each a plurality of vehicles for sale, the assessing based on one or more of a condition, a make, and a model of each vehicle;
integrating the assessed market value of one of the plurality of vehicles into a market model based on market information related to the make and the model of the one vehicle, the market model including an adaptive pricing strategy for the one vehicle;
setting a seller-side pricing preference for the one vehicle based on the adaptive pricing strategy for the one vehicle;
obtaining a set of buyers having one or more of a vehicle budget and a vehicle purchase category in accordance with the adaptive pricing strategy for the one vehicle;
assigning each buyer in the set of buyers a purchase ranking corresponding to an extent one or more of the vehicle budget and the vehicle purchase category corresponds to the adaptive pricing strategy for the one vehicle;
matching one of the buyers in the set of buyers with the one vehicle according to the purchase ranking of the one buyer;
obtaining, for the one buyer, a buyer-side pricing preference for the one vehicle based on the adaptive pricing strategy and a marketing model for the one vehicle;
facilitating a sale of the one vehicle to the one buyer.

12. The method of claim 11, wherein facilitating the sale of the one vehicle comprises:
receiving a bid for the one vehicle from the one buyer;
facilitating acceptance of the bid by a seller.

13. The method of claim 11, wherein facilitating the sale of the one vehicle comprises:
facilitating legal transfer of the one vehicle from a seller to the one buyer;
facilitating payment for the one vehicle from the one buyer to the seller.

14. The method of claim 11, wherein facilitating the sale of the one vehicle comprises:
providing a set of instructions to a seller to physically prepare the one vehicle for delivery to the one buyer;
coordinating the delivery of the one vehicle from the seller to the one buyer.

15. The method of claim 11, wherein the vehicle comprises one or more of: a car, an airplane, a boat, a train, a bus, a bicycle, a motorcycle, and a skateboard.
